(19) United States
(12) Patent Application Publication
(10) Pub. No.: US 2011/0266827 A1
(43) Pub. Date: Nov. 3, 2011

(54) GUIDE ASSEMBLY FOR INTERIOR LINING OF CONVERTIBLE VEHICLE

(75) Inventors: Markus Sczuka, Stuttgart (DE); Bärbel Reuter, Ludwigsburg (DE); Josef Epli, Markgroningen (DE)

(73) Assignee: MAGNA CAR TOP SYSTEMS GMBH, Bietigheim-Bissingen (DE)

(21) Appl. No.: 13/097,358

(22) Filed: Apr. 29, 2011

(30) Foreign Application Priority Data
Apr. 30, 2010 (DE) 10 2010 018 925.1

(51) Int. Cl. B62D 25/06; B60J 7/12

(52) U.S. Cl. 296/107.06; 296/107.01

(57) ABSTRACT

A guide assembly for an interior lining of a folding top of a vehicle includes a pillar configured to move as the folding top moves, a pull rope connected at one end to the interior lining, and a guide track fixedly connected to the pillar. The pull rope is configured to pull the interior lining as the folding top moves. The guide track has a wrap-around. An edge region of the interior lining is movably held in the wrap-around of the guide track such that the edge region of the interior lining can slide along the guide track as the interior lining is being pulled by the pull rope as the folding top moves.

### CROSS-REFERENCE TO RELATED APPLICATIONS

This application claims foreign priority benefits under 35 U.S.C. §119(a)-(d) to DE 10 2010 018 925.1, filed Apr. 30, 2010, which is hereby incorporated by reference in its entirety.

### TECHNICAL FIELD

The present invention relates to a guide assembly for the interior lining of a folding top of a convertible vehicle.

### BACKGROUND

A folding top (i.e., a collapsible roof) for a convertible vehicle is movable between closed and opened positions. In the closed position, the folding top extends over and covers the passenger compartment of the vehicle. In the opened position, the folding top is rearwardly lowered into a storage space in the rear end of the vehicle. A folding top drive assembly or the like is configured to move the folding top between the closed and opened positions.

A folding top may include an outer fabric cover and an interior lining. The interior lining is applied in the form of a headliner oriented parallel to the outer fabric cover on the inner side of the folding top. The interior lining can conceal levers, linkages, and the like of the folding top drive assembly and can achieve an attractive design for the inside of the folding top. This enables the interior lining to be composed from individual parts, wherein parts of the lining can be clamped onto support rails in the edge regions of the folding top. When the folding top is moved between the closed and opened positions, both the outer fabric cover and the interior lining have to fold according to a predetermined pattern. So-called plaiters may be used for this purpose to pull the outer fabric cover and the interior lining into predetermined positions with respect to moving support arms or convertible top bows.

Extreme pivoting motions due to the support arm kinematics of the folding top when the folding top is closing can damage the material of regions of the interior lining, particularly the interior side linings A pull rope and an elastic band are provided to avoid this problem. The pull rope pulls an interior side lining into position when the folding top is closing. The pull rope is located in the region between the interior lining and the outer fabric cover. The pull rope is brought to and retained in a desired position through binding points on the interior side lining by deflecting a number of times through deflection eyes or pulleys. The elastic band produces tension in the material of the interior lining by stretching the interior lining during the motion of the folding top from the opened position into the closed position. Tearing or other damage to the interior lining is inhibited through the elongation of the elastic band. A spring can be incorporated into the pull rope so that the pull rope acts under tension and the edge region of the interior lining holds its shape.

DE 40 31 270 C1 describes a folding top for a convertible vehicle. A top rail is between an outer cover and an inner cover. The top rail has movable linkages that can carry out multiple superposed spatial movements when the folding top is opening or closing. In order to prevent damage to the covers and to enable free motion of the inner cover on the top rail, the inner cover is fastened to a first linkage assembly and is guided to a second linkage assembly by traction elements. In this way the inner cover can be pulled and tightened relative to the second linkage assembly under continuous pretension. The traction elements for stretching the inner cover can be guided through linkage assemblies by deflecting elements. The traction elements are held by elastic elements such as springs. These elastic connections ensure that reductions in length of the traction elements are compensated for when the folding top is closing. The traction elements are fastened to linkage assembly elements and pass through eyes or other retaining fixtures in the inner cover such that they are held or stretched depending on the position of the linkage assembly elements. When the folding top is opening, the inner cover can be placed in predetermined positions by the traction elements to form folds during stowage.

DE 102 36 511 B3 describes a folding top for a convertible vehicle. The folding top includes an outer cover and a folding top linkage assembly with movable linkage assembly components and an internal headliner. The headliner is moved or pulled by a closing motion of the folding top linkage assembly through a force-transmitting control mechanism relative to the folding top linkage assembly. Both tensile and compressive forces are transmittable through the control mechanism, wherein the control mechanism actively moves the headliner into a predetermined folded position when the folding top is opening. When the folding top is closing, the interior headliner is pulled by the control mechanism into a position that conceals the top rail. The traction forces and the motions are adjusted to maximum dimensions of the headliner. Side regions of the headliner can have connection flaps or support rails that are acted upon by Bowden cables. The Bowden cables are connected to the control mechanism according to the motion of the linkage assembly. In this way, both the regions of the interior lining and the flap elements for the passage of linkage assembly components can be actuated through the control mechanism.

DE 10 2005 020 650 A1 describes a folding top for a convertible vehicle. The folding top is movable between closed and opened positions by a folding top kinematic mechanism. The kinematic mechanism is incorporated between an outer cover and an inner cover. The kinematic mechanism has reinforcing elements that are connected with edge regions of the inner cover. The inner cover together with the reinforcing elements can rest against at least one of the linkage assemblies due to traction elements that are attached to the reinforcing elements, wherein the kinematic mechanism is concealed from the interior of the vehicle by the inner cover. The reinforcing element has at least one guide element which is fixed to the reinforcing element. When the folding top is closing, the reinforcing element is pressed against the linkage assembly component by the folding top material and the traction elements, wherein the reinforcing element and the guide element respectively lie with one surface on the linkage assembly component.

### SUMMARY

An object of the present invention includes a guide assembly for adjusting in position the interior lining of a folding top of a convertible vehicle in which the guide assembly is relatively simple to assemble.

In carrying out the above object and other objects, the present invention provides a guide assembly for an interior lining of a folding top of a vehicle. The guide assembly includes a pillar configured to move as the folding top moves, a pull rope connected at one end to the interior lining, and a guide track fixedly connected to the pillar. The pull rope is configured to pull the interior lining as the folding top moves. The guide track has a wrap-around. An edge region of the interior lining is movably held in the wrap-around of the guide track such that the edge region of the interior lining can slide along the guide track as the interior lining is being pulled by the pull rope as the folding top moves.

Also, in carrying out the above object and other objects, the present invention provides a folding top assembly. The folding top assembly includes a folding top movable between closed and opened positions, a pillar configured to move as the folding top moves, a pull rope connected at one end to the interior lining, and a guide track fixedly connected to the pillar. The folding top has an interior lining. The pull rope is configured to pull the interior lining as the folding top moves. The guide track has a wrap-around. An edge region of the interior lining is movably held in the wrap-around of the guide track such that the edge region of the interior lining can slide along the guide track as the interior lining is being pulled by the pull rope as the folding top moves.

Embodiments of the present invention provide a guide assembly for the interior lining of a folding top of a convertible vehicle. The folding top is movable between a closed position and an opened position. A folding top kinematic mechanism is configured to move the folding top between the closed and opened positions. The interior lining at least partially conceals a C-pillar of the folding top as well as the region between the C-pillar and a rear roof part of the folding top. The C-pillar borders a side window of the vehicle when the folding top is in the closed position and the side window is closed. Support arms of the folding top kinematic mechanism are located in the region between the C-pillar and the rear roof part. The edge region of the interior lining facing the side window matches the form and shape of the C-pillar. A pull rope pulls and stretches the interior lining into a final position concealing the region between the C-pillar and the rear roof part as the folding top moves. The edge region of the interior lining facing the side window is gripped in a wrap-around of a guide track fixedly connected to the C-pillar, whereby a comparatively simple mountable guide is formed in which the interior lining can be moved.

Embodiments of the present invention are based on the concept that for a folding top adjustable between closed and opened positions, the region of the folding top facing the interior compartment of the vehicle is covered with a fabric. This interior lining, also known as a headliner, includes a plurality of parts, wherein the region facing toward the roof is connected to the folding top with cords and bands or by convertible top bows and support arms. The side supports of the roof in the side region of the folding top, as well as C-pillars, are covered with an interior lining so that when the folding top is closed the linkage assemblies and support arms are covered by the interior lining. The interior lining of the C-pillar is a relatively large area fabric part and is connected to the C-pillar in the region of its headliner facing toward the roof section or overlapped by its edge region. In the case of an opening folding top, the C-pillar and the roof side supports and support arm for the folding top kinematic mechanism pivot so that the interior lining of the C-pillar cannot follow because of its dimensions and flexibility. Consequently, the interior lining of the C-pillar would become damaged or wear out if the interior lining material was repeatedly subjected to excessive stretching thereby significantly reducing its lifetime.

Another negative feature is that the interior lining of the C-pillar has to conform to the mostly cambered contour of the C-pillar in the edge region of the C-pillar. This is difficult to do in the case of a stretched fabric. In the edge region of the C-pillar, as well as the inner passenger compartment facing it, the C-pillar has a guide track that corresponds to the contour and shape of the C-pillar. The guide track is rigidly connected to the C-pillar. A guide having a wrap-around is associated with the C-pillar. The edge region of the interior lining of the C-pillar facing toward the side window continues in the wrap-around region, which is led inside the wrap-around into the guide track. For this purpose, a welting is in the edge region of the interior lining. The welting together with the surrounding fabric of the lining corresponds to the inner dimensions of the guide track wrap-around.

When the folding top is opening, the interior lining of the C-pillar slides along the guide track as the edge region of the interior lining is gripped in the wrap-around. The displacement conforms to the required dimensions of the pivoting motion. When the folding top is closing, the interior lining of the C-pillar is pulled in the direction of the belt line of the side window by a pull rope. The pull rope is affixed in the corner region of the interior lining of the C-pillar. The interior lining of the C-pillar thus slides in the guide track into its position by which the C-pillar and parts of the roof side support and the support arm kinematic mechanism can be spanned.

A variant includes guides that can be sewn in the edge region of the interior lining of the C-pillar that extend into the wrap-around of the guide track. The guides slide inside the guide track when the folding top is opening. An elastic connection is between the guides and the edge region of the interior lining of the C-pillar. The guide track can be located in the region of the C-pillar and in regions of the roof side supports or in the transition region to the inner headliner of the folding top, whereby the interior lining of the C-pillar can be arranged so that it can be displaced along the guide track.

In order to conceal the part of the wrap-around that projects in the direction of the side window with the interior lining of the C-pillar, a protruding fabric lip or elastomer lip like component is sewn into the edge region of the interior lining of the C-pillar facing the guide track. The use of such a guide track is advantageous as the guide track can be attached to the C-pillar by fasteners such as screws and can thereby be adjusted by the fasteners and associated holes through the guide track within certain limits relative to the C-pillar.

The guide track can be fabricated from an aluminum extrusion and bent according to the shape and contour of the C-pillar. The guide track can be an injection molded component colored to match the interior lining of the C-pillar. The pull rope that pulls the interior lining of the C-pillar is attached in the rear region of the bodywork or to a support arm of the support arm kinematic mechanism. The pull rope can be attached to the bodywork or to the support arm by an elastic element or a spring in the connection region as overload protection for the movable interior lining.

It is to be understood that the aforementioned and subsequently described features are not only useable in the combinations presented but are also useable in other combinations or separately without falling outside of the framework of the present invention.

The above features, and other features and advantages of the present invention are readily apparent from the following detailed description thereof when taken in connection with the accompanying drawings.

### BRIEF DESCRIPTION OF THE DRAWINGS

FIG. 1 illustrates an internal view of a folding top having an interior lining movably connected to a C-pillar of a convertible vehicle by a guide assembly in accordance with an embodiment of the present invention in which the folding top is in a closed position;

FIG. 2 illustrates the folding top being in a partially opened position and the interior lining being partially displaced;

FIG. 3 illustrates the forward entrance region of a guide track of the guide assembly with the folding top being in a partially opened position and the interior lining being partially displaced;

FIG. 4 illustrates the rearward region of the guide track and a pull rope of the guide assembly with the folding top being in a partially opened position and the interior lining being partially displaced; and

FIG. 5 illustrates a section through the guide track and a welting of the interior lining.

### DETAILED DESCRIPTION

As required, detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

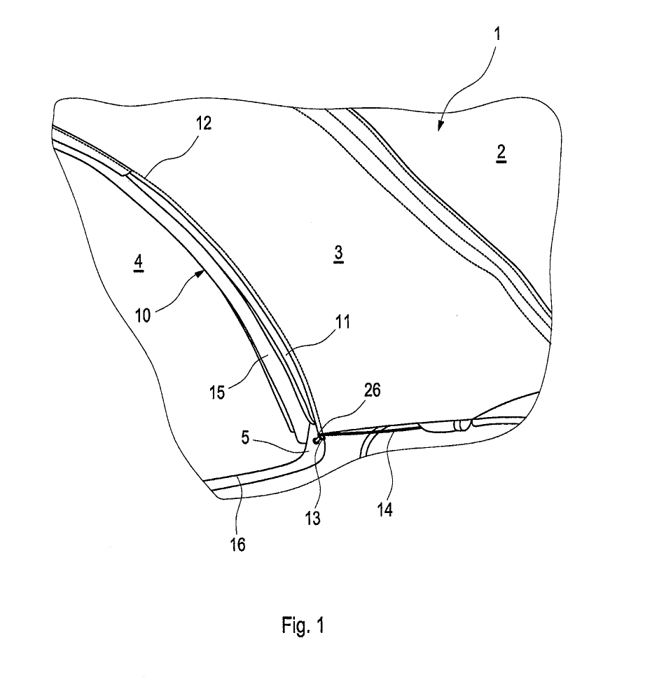

Referring now to FIG. 1, an internal view of a folding top 1 having an interior lining 3 movably connected to a C-pillar 5 of a convertible vehicle by a guide assembly in accordance with an embodiment of the present invention is shown. In FIG. 1, folding top 1 is in its closed position. Interior lining 3 of C-pillar 5 is attached at a rear roof element 2 of folding top 1. This attachment can be carried out by a hook-and-loop fastener or other fasteners. An interior headliner (not shown) overlaps the region of interior lining 3 facing rear roof element 2 resulting in a homogeneous appearance. Interior lining 3 may be sewn together with the headliner in a transition region to form a single component supported on folding top 1.

C-pillar 5 borders a side window 4 of the vehicle when folding top 1 is in the closed position and the side window is closed. C-pillar 5 includes a seal 15 in the region of side window 4. Seal 15 has a gap that is used as a holding region 30 for side window 4.

The guide assembly includes a guide track 10. Guide track 10 has a wrap-around 11 which points toward the interior of the vehicle. Seal 15 is bordered with wrap-around 11 of guide track 10. An end region of interior lining 3 facing toward side window 4 is gripped and guided in wrap-around 11 of guide track 10.

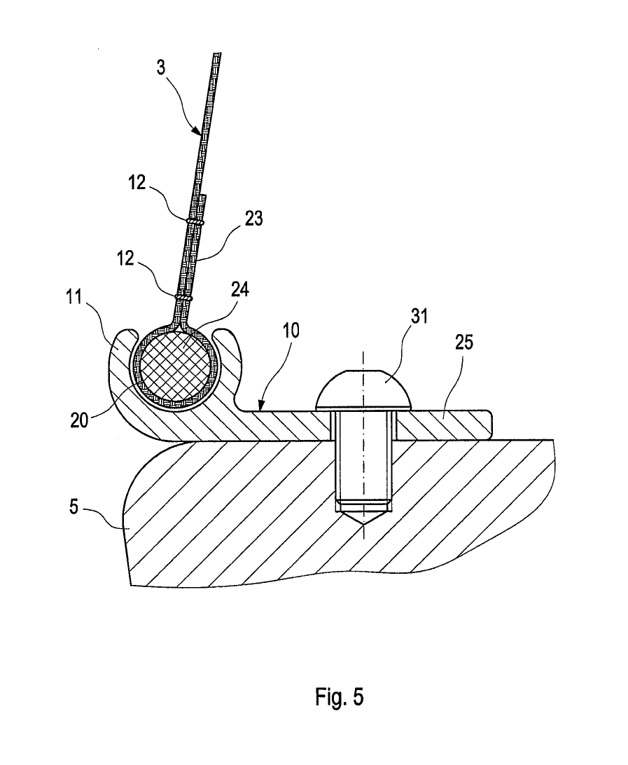

With reference to FIG. 5, the end region of interior lining 3 includes a welting 24 for enabling interior lining 3 to be gripped and guided in wrap-around 11 of guide track 10. Welting 24 is surrounded by interior lining 3. Welting 24 together with the surrounding interior lining 3 corresponds to the internal dimensions of wrap-around 11 of guide track 10.

Turning back to FIG. 1, the guide assembly further includes a pull rope 14. In the corner region of interior lining 3 near the intersection of C-pillar 5 with a belt line 16, pull rope 14 is attached to interior lining 3 through a pull rope connection 26. Pull rope 14 is fixed by its free end, for example, in the rear region of the vehicle body. Pull rope 14 pulls interior lining 3 when folding top 1 is in its closed position into a final position covering the support arm kinematic mechanism. To do this, pull rope 14 is deflected through a bending eye 13 that is located in the corner region of C-pillar 5.

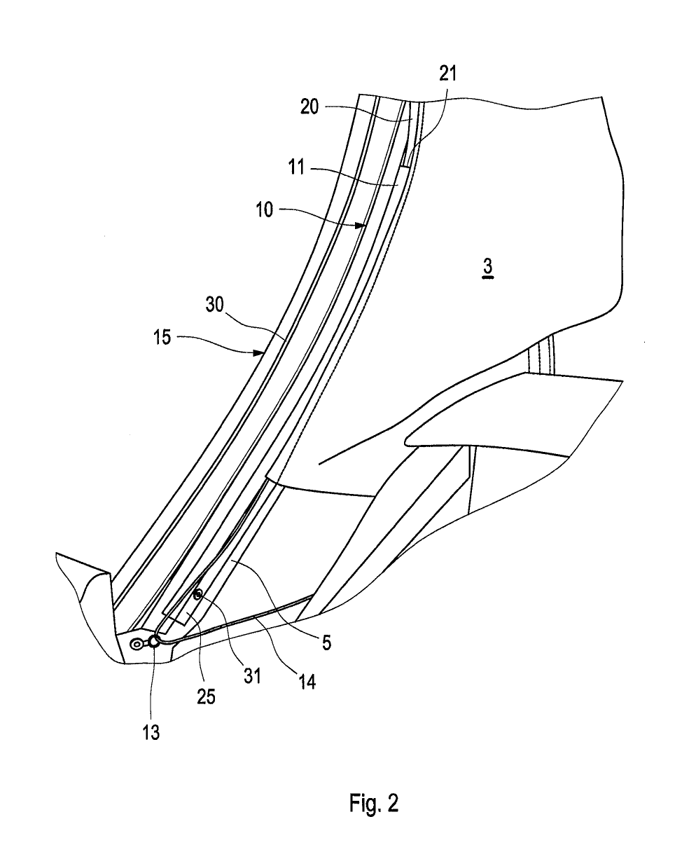

Referring now to FIG. 2, interior lining 3 partially displaced as a result of folding top 1 being in a partially opened position is shown. Folding top 1 being moved from its closed position to the partially opened position shown in FIG. 2 results in the edge region of interior lining 3 being displaced partially within wrap-around 11 of guide track 10 in the direction of a roof side support (not shown). The tensile stress on interior lining 3 required for this purpose arises because interior lining 3 is attached to a front region of folding top 1 and is accordingly displaced by the resulting tensile force in interior lining 3 as C-pillar 5 pivots toward the rear.

Guide track 10 is attached to the side of C-pillar 5 facing the interior of the vehicle by suitable fasteners 31 such as screws. Pull rope 14 is led through bending eye 13 of interior lining 3 according to a displacement path of interior lining 3 resulting from movement of folding top 1 to the opened position. An entrance 21 is at the forward end of guide track 10. A portion of interior lining 3 with a wrap-around 20 of welting 24 emerges from entrance 21. As folding top 1 continues to close, wrap-around 20 of welting 24 inserts further through entrance 21 into guide track 10.

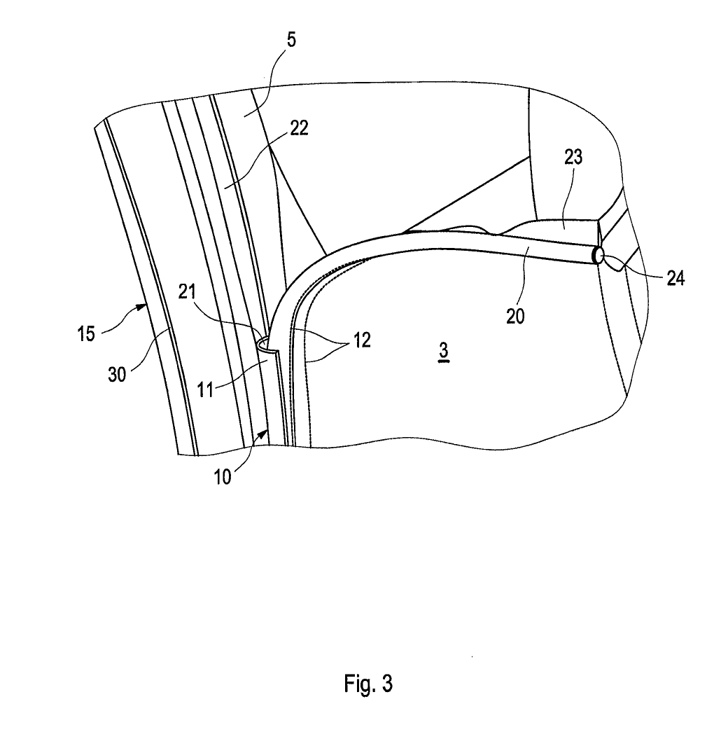

As shown in FIG. 3, an enlargement of the forward entrance region of guide track 10 is formed with the partially extracted interior lining 3 of C-pillar 5. Guide track 10 is attached here through fastener 31 in a guide track contact surface 22 of C-pillar 5. A seal in the form of a flat elastic band or an expanded seal can be held freely supported in contact surface 22 between C-pillar 5 and guide track 10. This procedure is suitable for impeding possible penetration of moisture in the fastening region of guide track 10 to C-pillar 5.

Wrap-around 11 of guide track 10 is formed as a claw-shaped element (shown best in FIG. 5). Welting 24 is surrounded by interior lining 3 in wrap-around 20. Welting 24 is captured in wrap-around 11 of guide track 10 such that welting 24, and thereby the end region of interior lining 3, can slide along guide track 10 as folding top 1 moves between the closed and opened positions. Wrap-around 20 of welting 24 is formed as a fabric wrapping 23. Fabric wrapping 23 is fixed with a seam 12 in the immediate wrap-around region of welting 24. Entrance 21 of guide track 10 can be formed with entrance bevels in order to facilitate introduction therein of welting 24 together with the surrounding interior lining 3.

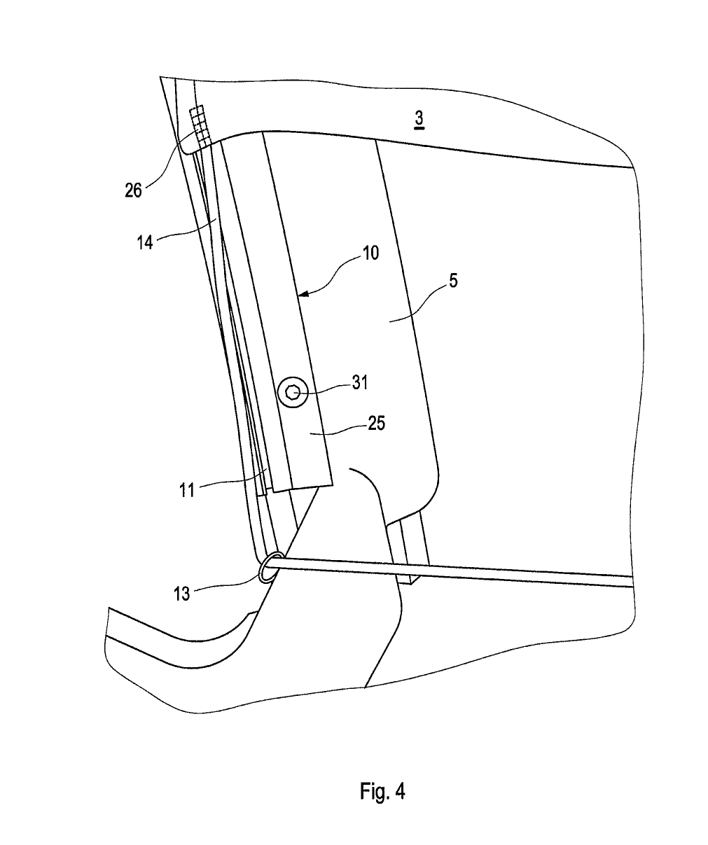

FIG. 4 shows the lower region of guide track 10 with a partially inserted interior lining 3 of C-pillar 5 as well as pull rope 14. Welting 24 is surrounded by interior lining 3 in pull rope connection region 26 between interior lining 3 and pull rope 14. While welting 24 together with the surrounding interior lining 3 is captured in wrap-around 11 of guide track 10 so that it can slide along guide track 10, pull rope 14 passes directly above wrap-around 11. Pull rope 14 is deflected through bending eye 13 both when folding top 1 is closing and opening. Bending eye 13 is attached to C-pillar 5 near wrap-around 11 of guide track 10. This attachment is necessary in order that pull rope 14 consistently passes at the same distance with respect to wrap-around 11 of guide track 10 while displacing interior lining 3.

Guide track 10 is formed with a side flange 25. Side flange 25 corresponds in its dimensions and shape to the form of C-pillar 5. Side flange 25 is fastened to C-pillar 5 by fasteners 31 such as clips, rivets, or the like. Guide track 10 can be formed integrally with C-pillar 5. However, attachment of guide track 10 as a separate component via a fastener 31 has advantages. For instance, employing a fastener 31 in the form of a screw enables adjustment of guide track 10 relative to C-pillar 5 in correspondence to holes drilled in guide track 10.

Another variant includes guide track 10 being combined with its wrap-around 11, for example, with a support flange for seal 15 such that seal 15 is at least partly attached through guide track 10.

FIG. 5 illustrates a section through guide track 10 and welting 24 of interior lining 3. Side flange 25 of guide track 10 is positioned and fixed to C-pillar 5 by fastener 31. The edge region of guide track 10 formed as wrap-around 11 grasps welting 24 of interior lining 3 so that welting 24 with interior lining 3 cannot slide out of wrap-around 11. However, wrap-around 20 surrounding welting 24 is designed so that sufficient clearance is present between the interior of wrap-around 11 to allow interior lining 3 to slide along guide track 10. The envelope fabric 23 of interior lining 3 is fastened by at least one seam 12 in the region directly behind welting 24.

The use of a plastic material for guide track 10 can influence friction arising during the sliding of interior lining 3 in the wrap-around 11. When a plastic material is used for the guide track 10, it can also be colored and matched to the color of the interior lining 3.

### LIST OF REFERENCE NUMBERS

1 folding top

2 rear roof part

3 interior lining

4 side window

5 C-pillar

10 guide track

11 wrap-around

12 seam

13 deflecting eye

14 pull rope

15 seal

16 belt line

20 wrap-around welting

21 wrap-around entrance

22 contact surface for guide track

23 fabric wrapping

24 welting

25 side flange

26 pull rope connection

30 side window holding region

31 fastener

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A guide assembly for an interior lining of a folding top of a vehicle, the guide assembly comprising:
a pillar configured to move as the folding top moves;
a pull rope connected at one end to the interior lining, the pull rope configured to pull the interior lining as the folding top moves; and
a guide track fixedly connected to the pillar, the guide track having a wrap-around;
wherein an edge region of the interior lining is movably held in the wrap-around of the guide track such that the edge region of the interior lining can slide along the guide track as the interior lining is being pulled by the pull rope as the folding top moves.

2. The guide assembly of claim 1 wherein:
the interior lining at least partially conceals the pillar and the region between the pillar and a rear roof part of the folding top.

3. The guide assembly of claim 1 wherein:
support arms for a folding top kinematic mechanism configured to move the folding top are between the pillar and a rear roof part of the folding top.

4. The guide assembly of claim 1 wherein:
the edge region of the interior lining corresponds to the form and shape of the pillar.

5. The guide assembly of claim 2 wherein:
the pull rope pulls and stretches the interior lining into a final position concealing the region between the pillar and the rear roof part.

6. The guide assembly of claim 1 wherein:
the pillar is a C-pillar.

7. The guide assembly of claim 1 wherein:
the guide track corresponds to the shape of the pillar.

8. The guide assembly of claim 1 wherein:
the guide track further includes a side flange, wherein the side flange is attached to the pillar by a fastener in order to fixedly connect the guide track to the pillar.

9. The guide assembly of claim 1 wherein:
the guide track includes at least one of metal and plastic.

10. The guide assembly of claim 1 wherein:
the wrap-around of the guide track includes entrance and exit regions having funnel-shaped enlargements.

11. The guide assembly of claim 1 wherein:
the wrap-around of the guide track is claw-shaped.

12. The guide assembly of claim 1 wherein:
the wrap-around of the guide track is circular with a wrap-around angle greater than 180 degrees.

13. The guide assembly of claim 1 wherein:
the edge region of the interior lining held in the wrap-around of the guide track is formed as a welting.

14. The guide assembly of claim 13 wherein:
the welting is surrounded by a portion of the interior lining.

15. The guide assembly of claim 1 wherein:
another end of the pull rope is attachable to the rear region of the vehicle body and the pull rope is configured so that the sliding of the interior lining along the guide track as the folding top opens matches flexibility of the pull rope.

16. The guide assembly of claim 1 wherein:
the pull rope passes adjacent to the wrap-around of the guide track.

17. A folding top assembly comprising:
a folding top movable between closed and opened positions, the folding top having an interior lining;
a pillar configured to move as the folding top moves;
a pull rope connected at one end to the interior lining, the pull rope configured to pull the interior lining as the folding top moves; and
a guide track fixedly connected to the pillar, the guide track having a wrap-around;
wherein an edge region of the interior lining is movably held in the wrap-around of the guide track such that the edge region of the interior lining can slide along the guide track as the interior lining is being pulled by the pull rope as the folding top moves.

18. The assembly of claim 17 wherein:
the wrap-around of the guide track is claw-shaped.

19. The assembly of claim 17 wherein:
the wrap-around of the guide track is circular with a wrap-around angle greater than 180 degrees.

20. The assembly of claim 17 wherein:
the edge region of the interior lining held in the wrap-around of the guide track is formed as a welting.
